(19) United States
(12) Patent Application Publication
(10) Pub. No.: US 2024/0070183 A1
(43) Pub. Date: Feb. 29, 2024

(54) TEXT MINING USING A RELATIVELY LOWER DIMENSION REPRESENTATION OF DOCUMENTS

(71) Applicant: International Business Machines Corporation, Armonk, NY (US)

(72) Inventors: Jia Li Yun, Beijing (CN); Yin Xiang Xiong, Beijing (CN); Shan Gu, Beijing (CN); Yan Bin Hu, Beijing (CN); Yao Zhang, Beijing (CN)

(21) Appl. No.: 17/895,730

(22) Filed: Aug. 25, 2022

(51) Int. Cl. G06F 16/35; G06F 16/33

(52) U.S. Cl. CPC G06F 16/355; G06F 16/3331; G06F 2216/03

(57) ABSTRACT

A computer-implemented method according to one embodiment includes generating a first matrix based on words extracted from documents, and generating a second matrix based on deduplication chunks. The deduplication chunks include words of the documents. Word clustering is performed based on an analysis performed on the second matrix. Each cluster of the words represents a feature of at least one of the documents. The method further includes generating a third matrix based on the first matrix and the clusters, and performing text mining using the third matrix. A computer program product according to another embodiment includes a computer readable storage medium having program instructions embodied therewith. The program instructions are readable and/or executable by a computer to cause the computer to perform the foregoing method.

### BACKGROUND

The present invention relates to text mining, and more specifically, this invention relates to enabling text mining using a relatively lower dimension representation of documents.

Text mining is one application of artificial intelligence. One primary goal of text mining is to mine useful information from human-readable documents. Most documents are composed of natural language. Natural language includes unstructured data which cannot be directly processed by machine learning algorithms. Therefore, text preprocessing is used to convert documents to structured data by extracting key words as features.

### SUMMARY

A computer-implemented method according to one embodiment includes generating a first matrix based on words extracted from documents, and generating a second matrix based on deduplication chunks. The deduplication chunks include words of the documents. Word clustering is performed based on an analysis performed on the second matrix. Each cluster of the words represents a feature of at least one of the documents. The method further includes generating a third matrix based on the first matrix and the clusters, and performing text mining using the third matrix.

A computer program product according to another embodiment includes a computer readable storage medium having program instructions embodied therewith. The program instructions are readable and/or executable by a computer to cause the computer to perform the foregoing method.

A system according to another embodiment includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3A is a flowchart of a method, in accordance with one embodiment of the present invention.

FIG. 3B is a flowchart of sub-operations of an operation of the flowchart of FIG. 3A.

FIGS. 4A-4G depict a progression of converting a relatively high dimension representation of documents to a relatively low dimension representation of the documents, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for enabling text mining using a relatively low dimension representation of documents.

In one general embodiment, a computer-implemented method includes generating a first matrix based on words extracted from documents, and generating a second matrix based on deduplication chunks. The deduplication chunks include words of the documents. Word clustering is performed based on an analysis performed on the second matrix. Each cluster of the words represents a feature of at least one of the documents. The method further includes generating a third matrix based on the first matrix and the clusters, and performing text mining using the third matrix.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as inventive code in block 200 for enabling text mining using a relatively low dimension representation of documents. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

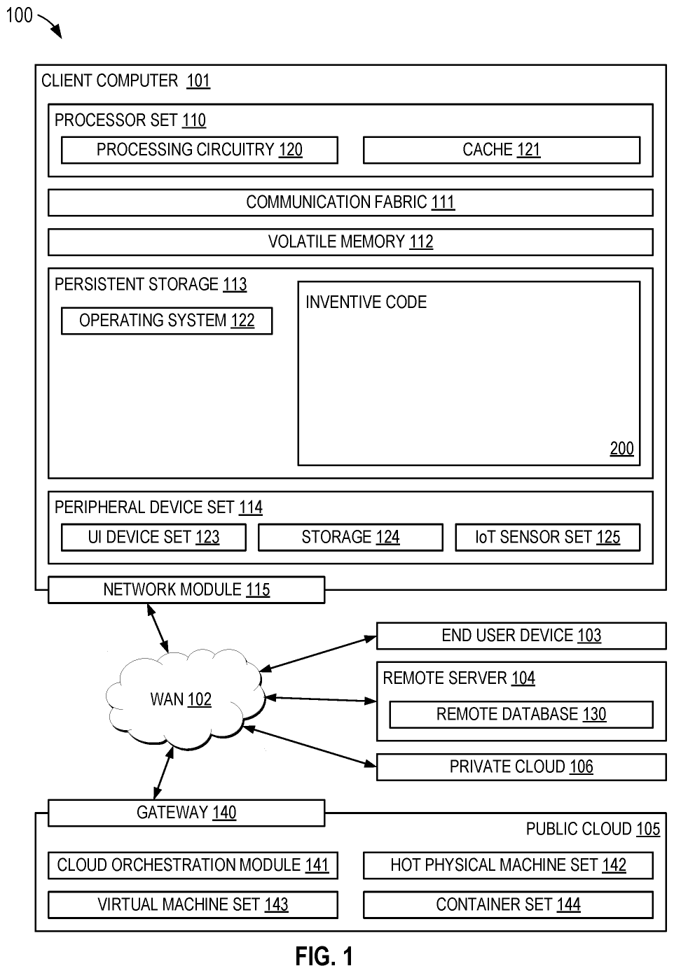

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

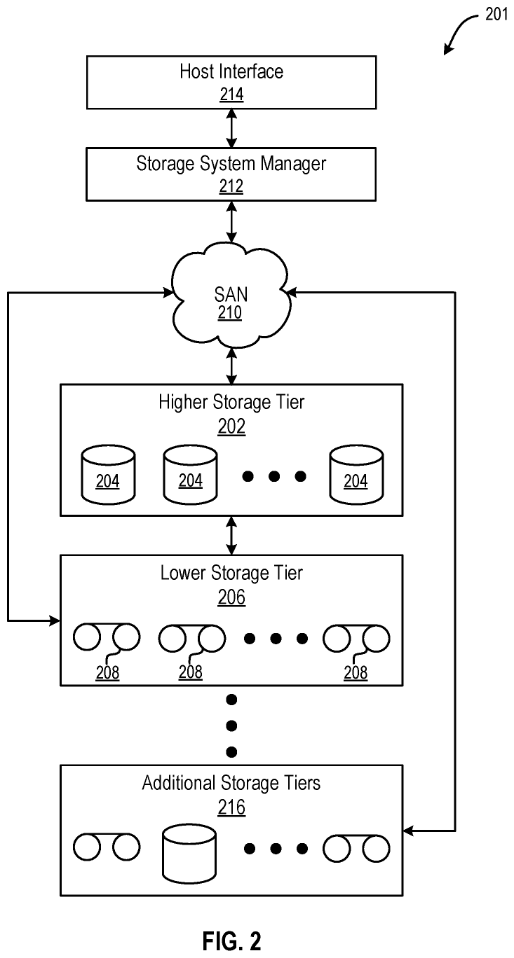

Now referring to FIG. 2, a storage system 201 is shown according to one embodiment. Note that some of the elements shown in FIG. 2 may be implemented as hardware and/or software, according to various embodiments. The storage system 201 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 201. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 201 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 201 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 201) may include logic configured to receive a request to open a data set, logic configured to determine if the requested data set is stored to a lower storage tier 206 of a tiered data storage system 201 in multiple associated portions, logic configured to move each associated portion of the requested data set to a higher storage tier 202 of the tiered data storage system 201, and logic configured to assemble the requested data set on the higher storage tier 202 of the tiered data storage system 201 from the associated portions.

Of course, this logic may be implemented as a method on any device and/or system or as a computer program product, according to various embodiments.

As mentioned elsewhere above, text mining is one application of artificial intelligence. One primary goal of text mining is to mine useful information from human-readable documents. Most documents are composed of natural language. Natural language includes unstructured data which cannot be directly processed by machine learning algorithms. Therefore, text preprocessing is used to convert documents to structured data by extracting key words as features.

Two problems should be considered during feature extraction. First, using relatively more key words generates relatively higher dimension features. This causes relatively high computational complexity in subsequent mining algorithms. Second, using relatively fewer key words causes a loss of more than a predefined amount of information. This likely affects the accuracy of mining results. Accordingly, choosing a feature set is a significant challenge within conventional text mining.

With the explosive growth of file corpora, e.g., such as a document set, in conventional use cases, deduplication storage is widely used to improve storage utilization and I/O. Deduplication is a specialized data compression technique for eliminating duplicate copies of repeating data. In the deduplication process, files are separated into chunks. Duplicated chunks are recognized by hash algorithms or physical hardware-based methods.

The techniques of various embodiments and approaches described herein apply a novel feature dimension reduction method by utilizing implied information in duplicated chunks to mitigate the problems of conventional feature extraction techniques described above.

More specifically, when files are saved into deduplication storage, content of the files is split into chunks. Words in the same chunks infers that the words have a relatively high frequency of occurring together and have a strong correlation. In the techniques of various embodiments and approaches described herein, the correlation of two words is measured by a count of the same chunks where they occur. The original words are grouped according to a correlation of the words. These groups are used as features, which are used to represent a document instead of words, with lower dimension. The new document representation may be used for text mining, such as classification. It may be prefaced that one advantage of using these techniques is that documents are able to be represented as sets of words, e.g., features, instead of original words. This enables a relatively lower dimension document representation, which supplies relatively more possibility and relatively higher efficiency for text mining task than otherwise merely using key words. Another advantage of using these techniques is that original words are merged into word-sets based on the chunks, which are identified by deduplication. The correlation information implied in chunks may then be utilized. Yet another advantage of using deduplication technology in these techniques includes identifying repeat patterns by hash algorithms, which allows for relatively much quicker identification than otherwise using conventional content-based methods.

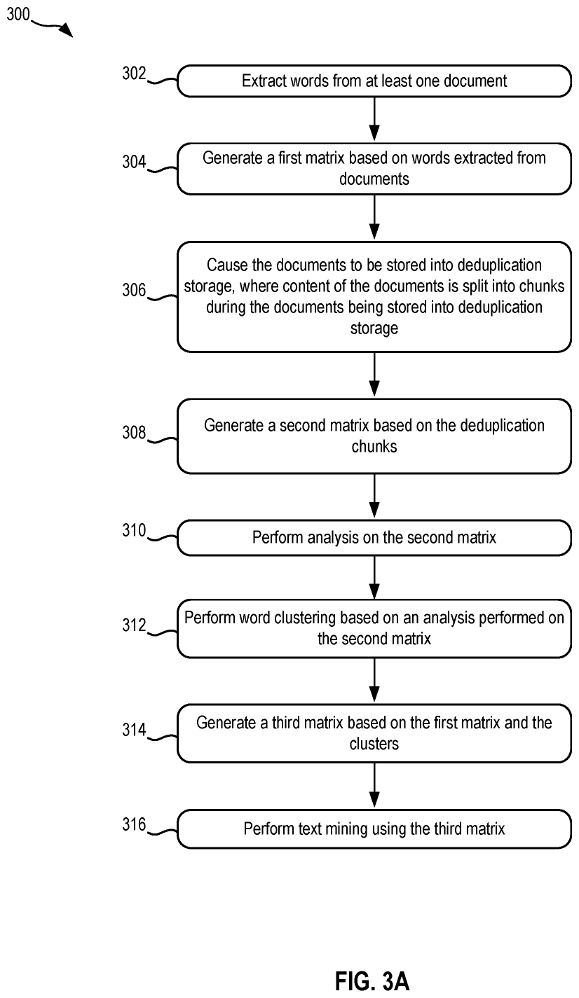

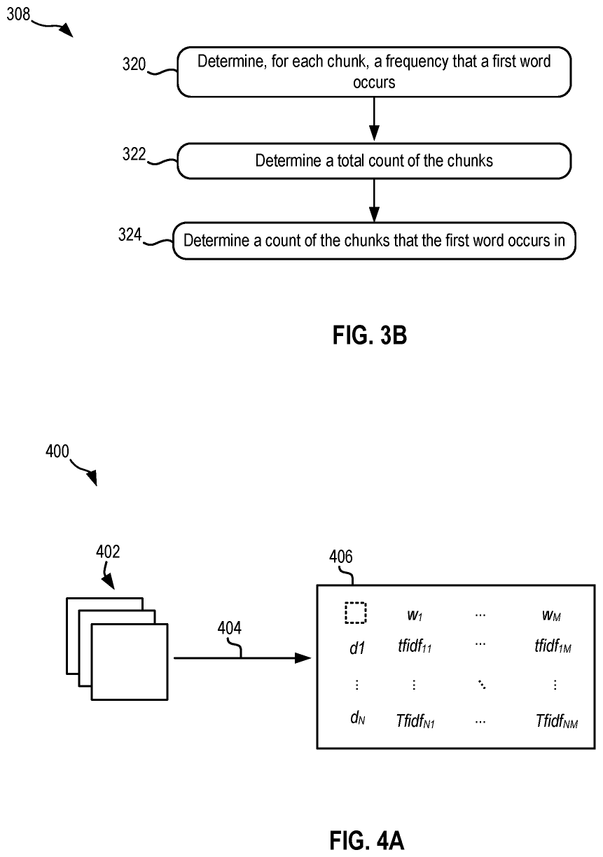

Now referring to FIG. 3A, a flowchart of a method 300 is shown according to one embodiment. The method 300 may be performed in accordance with the present invention in any of the environments depicted in FIGS. 1-4G, among others, in various embodiments. Of course, more or fewer operations than those specifically described in FIG. 3A may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Operation 302 includes extracting words from at least one document. Note that although extraction is performed on at least one document in operation 302, in some preferred approaches, words are extracted from a plurality of documents. The documents may be of a known type. For example, in some approaches the documents are a known type of human-readable documents, e.g., such as text documents. In another approach, the documents may additionally and/or alternatively be original documents. For example, the original documents may be documents that have not had any known type of data normalization process performed thereon.

In some approaches, text preprocessing may be performed on the documents to extract the words. For example, in some approaches, words may be extracted from documents using one or more techniques for text processing that would become apparent to one of ordinary skill in the art upon reading the descriptions herein. It should be noted that each of the documents may be a readable original file. Accordingly, although various operations described in method 300 are performed with respect to documents, in some approaches, one or more of the documents may be one or more readable files.

Operation 304 includes generating a first matrix based on words extracted from the documents. In one preferred approach the first matrix may be a “word-documents dimensional matrix.” For example, in one approach, elements of the first matrix may indicate a frequency that a given word appears in a given one of the documents. A known technique for counting a number of times that a given word occurs in each document may be utilized. More specifically, columns of the first matrix may represent words of the documents, rows of the first matrix may represent the documents, and thereby the elements of the first matrix may indicate a frequency that a given word appears in a given one of the documents.

In one illustrative approach, assuming that a total document count is N, a word count is M, by calculating fᵢⱼ the frequency of word wⱼ occurs in document dᵢ, and dfⱼ is a count of documents that a given word wⱼ occurs in, the first matrix may be generated and/or represented by the equations below, e.g., see Equation(1)-Equation(2). In some approaches the first matrix may be referred to as a “get documents-words matrix.” That is, each document dᵢ is represented as a high dimension vector.

$${\overline{d}}_{i} = ( {tfidf}_{i 1} , {tfidf}_{i 2} , … , {tfidf}_{iM} ) \qquad Equation ( 1 )$$

$${tfidf}_{ij} = \frac{{f}_{ij}}{{\sum }_{j = 1}^{M} {f}_{ij}} \times log ( \frac{N}{{df}_{j}} ) \qquad Equation ( 2 )$$

The documents are caused to be stored into deduplication storage in some approaches, e.g., see operation 306. It should be noted that the documents may be stored into the deduplication storage at any time. For example, in one approach at least some of the documents are stored into the deduplication storage before the words are extracted from the documents and/or the first matrix being generated. In another approach, the documents are ongoingly stored into the deduplication storage over time, e.g., such as in a plurality of data storage operations performed subsequent to I/O operations associated with the documents being performed in a known type of computer-based network. In yet some other approaches, at least some of the documents may be stored into the deduplication storage subsequent to extraction of the words from the documents and/or the first matrix being generated. The deduplication storage may be located on one or more known type of storage devices in one or more known type of networks.

It should be noted that although various operations of method 300 are preferably performed with respect to words of the documents, the techniques of method 300 may additionally and/or alternatively be performed using other content of the documents. For example, the content may additionally and/or alternatively include, e.g., punctuation, numbers, formulas, emojis, character strings, script, etc., of the documents.

Causing the documents to be stored into the deduplication storage may in some approaches include issuing an instruction, e.g., to a controller and/or processor, to perform the data storage operation. In some approaches, content of the documents is split into chunks during the documents being stored into deduplication storage. More specifically, the content includes words in some preferred approaches.

Operation 308 includes generating a second matrix based on the deduplication chunks. In some preferred approaches the deduplication chunks include words, e.g., contents, of the documents. It should be noted that because more than just words of the documents may be stored on the deduplication chunks, e.g., the deduplication may additionally and/or alternatively include punctuation, strings of numbers, etc., in addition to the words, in some approaches, the words may be extracted from the deduplication chunks in the process of generating the second matrix. One or more word recognition techniques may be performed to identify and extract the words in the chunks.

In one preferred approach, elements of the second matrix may indicate a frequency that a given word appears in a given one of the deduplication chunks. More specifically, columns of the second matrix may represent chunks of the deduplication storage, rows of the second matrix may represent the words, and thereby the elements of the first matrix may indicate a frequency that a given word appears in a given one of the deduplication chunks. Looking to FIG. 3B, exemplary sub-operations of generating a second matrix based on the deduplication chunks of the deduplication storage are illustrated in accordance with one embodiment, one or more of which may be used to perform operation 308 of FIG. 3A. However, it should be noted that the sub-operations of FIG. 3B are illustrated in accordance with one embodiment which is in no way intended to limit the invention.

In some approaches, generating the second matrix based on deduplication chunks of the deduplication storage may include determining, for each chunk, a frequency that a first word occurs, e.g., see sub-operation 320 of FIG. 3B. For context, although various sub-operations and/or operations of method 300 are described with respect to a “first word,” such sub-operations and/or operations may additionally and/or alternatively be performed with respect to at least a plurality of words, and in some approaches each of the words of the documents. For example, in some preferred approaches, a frequency for each word in each chunk is determined. Techniques for determining, for each chunk, a frequency that a given word appears may include using one or more word counting techniques that would become apparent to one of ordinary skill in the art upon reading the descriptions herein. A total count of the chunks may additionally and/or alternatively be determined, e.g., see sub-operation 322. In some approaches the total count of the chunks may be determined from data and/or metadata of the deduplication storage. In some other approaches a known type of count algorithm that is configured to determine a count of chunks in a deduplication storage may be performed. A count of the chunks that the first word occurs in, may additionally and/or alternatively be determined for generating the second matrix, e.g., see sub-operation 324. Techniques for determining a count of the chunks that a given word, e.g., such as the first word, occurs in that would become apparent to one of ordinary skill in the art upon reading the descriptions herein may be utilized for performing sub-operation 324. The second matrix may be generated and include the determined frequencies and counts of sub-operations 320-324.

With reference again to FIG. 3A, in one illustrative approach, upon the documents being saved into deduplication storage, content of the documents may be split into chunks. In some approaches, the second matrix may be generated and/or represented by the equations below, e.g., see Equation(3)-Equation(4). Based on the content of chunks, the second matrix, e.g., which may be referred to as a “get word-chunk matrix,” may in some approaches be generated by counting how many times a given word wⱼ occurs in a chunk cₗ. That is, word wⱼ may be represented as a vector in the equations below.

$${\overline{w}}_{j} = ( {tficf}_{j 1} , {tficf}_{j 2} , … , {tficf}_{j L} ) \qquad Equation ( 3 )$$

$${tficf}_{jl} = \frac{{f}_{jl}^{′}}{{\sum }_{j = 1}^{M} {f}_{jl}^{′}} \times log ( \frac{L}{{cf}_{j}} ) \qquad Equation ( 4 )$$

where “fⱼₗ′” represents the frequency word “wⱼ” occurs in chunk “cₗ”, “L” represents a total count of chunks, and “cfⱼ” represents a count of chunks that the word “wⱼ” occurs in. In some approaches, this process may be performed for a plurality of the words such that a plurality of vectors are determined.

Operation 310 includes performing analysis on the second matrix. More specifically, in some approaches, one or more predetermined analyzing operations may be performed on elements of the second matrix to determine relational information about at least some of the elements with respect to at least some of the other elements. For example, in one preferred approach, performing analysis on the second matrix may include calculating a distance between two words based on the word vectors, e.g., see Equation(3)-Equation(4). In some illustrative approaches the distance between a first word “w̅ₐ” and a second word “w̅_{b}” may be determined using Equation (5) below.

Distance(w̅ₐ,w̅_{b})=\sqrt{Σₗ₌₁^{L}(tficfₐₗ−tficf_{bl})²} Equation (5)

Words of the documents are merged into word-sets, e.g., clusters, based on the deduplication chunks. More specifically, operation 312 includes performing word clustering based on an analysis performed on the second matrix. For example, in some preferred approaches, word clustering may be performed based on the determined distances between words. Such word clustering techniques may include identifying repeat patterns, e.g., words having a high correlation with one another, by performing one or more hash algorithms. The clusters establish a new feature of the document based on words of the same cluster having relatively high correlation with one another. In other words, words with a relatively high correlation are merged into one feature as a result of performing the word clustering, while words with a relatively low correlation are not merged into the same feature as a result of performing the word clustering. In some approaches, one or more word clustering techniques that would become apparent to one of ordinary skill in the art upon reading the descriptions herein may be utilized. In such techniques, one or more predetermined thresholds may be utilized to establish degrees of correlation. For example, a predetermined upper threshold may be used to define words having relatively high correlation with one another, e.g., two or more words having characteristics that cause the upper threshold to be exceeded may be determined to have a relatively high correlation with one another. In contrast, a predetermined lower threshold may additionally and/or alternatively be used to define words having relatively low correlation with one another, e.g., two or more words having characteristics that do not exceed the lower threshold may be determined to have a relatively low correlation with one another and thereby not included in the same cluster. Note that in some approaches, some words may be determined to not have at least a predetermined degree of correlation with other words of the documents. In some approaches, these unique words may be placed in a cluster with one or more other words determined to be unique. In some other approaches, each word determined to be unique may be placed in a separate cluster. In yet some other approaches, words that are determined to be unique may be excluded from the clusters, e.g., as negligible outliers. For example, in some approaches filtering may be performed to filter out, e.g., clusters that contain only a single word, one or more words that are not incorporated into a cluster based on the one or more words being determined to not have at least a predetermined threshold of correlation with at least one or more other words, words that are mentioned less than a predetermined number of times in one or more of the documents, etc.

Accordingly, a plurality of clusters may be established, that each include two or more words determined to have a relatively high correlation with one another. Each cluster of the words represents a feature of at least one of the documents. For context, a feature defines a plurality of words that have a relatively high correlation with one another in one or more of the documents. As will be described elsewhere below, these features may be used to generate a matrix having a relatively lower dimension than the first matrix in order to enable efficient and accurate text mining of the documents, e.g., see operations 314-316.

A third matrix is generated based on the first matrix and the clusters, e.g., see operation 314. Because the clusters are in some approaches based on the second matrix, the third matrix may be additionally and/or alternatively be generated based on the second matrix. In some preferred approaches, elements of the third matrix indicate a frequency that a given feature appears in a given one of the documents. Accordingly, in one or more of such approaches, columns of the third matrix may represent the features, rows of the third matrix may represent the documents, and thereby the elements of the third matrix may indicate frequency that a given feature appears in a given one of the documents.

It should be noted that because at least some of the features correspond to a plurality of words determined to have a relatively high correlation with one another, the first matrix is a relatively higher dimension representation of the documents, and the third matrix is a relatively lower dimension representation of the documents. For context, dimensions of the relatively higher dimension representation associated with the first matrix include words of the documents, e.g., words extracted from the documents, while dimensions of the relatively lower dimension representation associated with the third matrix include the features of the documents, e.g., the features determined as a result of performing word clustering. Accordingly, generating the third matrix may include using the clusters to convert the relatively high dimension representation of the documents in the first matrix to the relatively low dimension representation of the documents in the third matrix.

Various illustrative approaches for converting a relatively high dimension vector representation of the documents to a relatively low dimension vector representation of the documents are described below. For example, in some approaches assuming that original key words are grouped into “K” clusters “{F₁, F₂, . . . , F_{K}},” a center vector “ūₖ” of cluster “Fₖ” may be represented using:

$${\overline{u}}_{k} = \frac{1}{\vert {F}_{k} \vert} {\sum }_{{w}_{j} ∈ {F}_{k}} {\overline{w}}_{j} \qquad Equation ( 6 )$$

where “w̅ⱼ” is the word vector, calculated using Equation (3)-Equation (4). A distance between word vector w̅ⱼ=(tficfⱼ₁, tficfⱼ₂, . . . , tficf_{jL}) and cluster center vector ūₖ=(uₖ₁, uₖ₂, . . . , u_{kL}) may be represented by:

Distance(w̅ⱼ,ūₖ)=\sqrt{Σₗ₌₁^{L}(tficfⱼₗ−uₖₗ)²} Equation (7)

Furthermore, such distance may be transferred to similarity using:

$$Similarity ( {\overline{w}}_{j} , {\overline{u}}_{k} ) = \frac{1}{Distance ( {\overline{w}}_{j} , {\overline{u}}_{k} )} ( If Distance ( {\overline{w}}_{j} , {\overline{u}}_{k} ) \neq 0 ) \qquad Equation ( 8 )$$

In some approaches, a given document is preferably represented as a relatively low dimension vector:

d̅ᵢ=(ffidfᵢ₁,ffidfᵢ₂, . . . ,ffidf_{iK}) Equation (9)

ffidfᵢₖ=Σⱼ₌₁^{M}Similarity(w̅ⱼ,ūₖ)×tfidfᵢⱼ Equation (10)

In some approaches, it may be determined whether the third matrix is a relatively low enough dimension vector representation of the documents. For example, it may be determined whether the third matrix includes less than a predetermined number of elements. In some approaches, it may be determined whether a difference between an element count of the third matrix and an element count of the first matrix is greater than a predetermined number. In response to a determination that the difference of the elements counts is greater than the predetermined number, the third matrix may be used for text mining, e.g., see operation 316. In contrast, in response to a determination that the difference of the elements counts is not greater than the predetermined number, one or more thresholds used for clustering the words may be increased and/or decreased a predetermined amount and the third matrix may be re-generated based on the updated clusters.

Method 300 optionally includes storing one or more of the matrixes and/or the clusters at one or more storage locations. These matrixes and/or clusters may be accessed thereafter, e.g., such as accessed from a storage location that a text mining algorithm has access to and/or draws information from.

Operation 316 includes performing text mining using the third matrix. More specifically, in some approaches, performing text mining using the third matrix may include running a predetermined text mining program on the relatively lower dimension representation of the documents. The text mining may be caused to be performed by issuing an instruction to execute the predetermined text mining program on the relatively lower dimension representation of the documents.

Numerous benefits are enabled as a result of performing various of the techniques described herein. For example, it should be noted that in some preferred approaches, data normalization is not performed to generate matrixes, e.g., the first matrix, the second matrix and the third matrix. Data normalization is relied upon in some conventional text mining techniques and therefore the techniques of various embodiments and approaches described herein relatively decrease an amount of processing that is performed in order to perform text mining on documents. It should also be noted that generating low dimensional representations of documents based on clusters generated from deduplication chunks of words of the documents has heretofore not been considered in conventional techniques. Instead, conventional text mining is often based on words of a relatively high dimensional representations of documents which causes relatively more computer processing and less computing efficiencies than otherwise using various techniques described herein for text mining relatively low dimension representation of documents. This is because these conventional techniques rely on using relatively higher representational dimension key words when text mining rather than using the relatively lower representational dimension clusters. Accordingly, the inventive discoveries disclosed herein with regards to use of generating a relatively low dimension representation of documents for text mining proceed contrary to conventional wisdom.

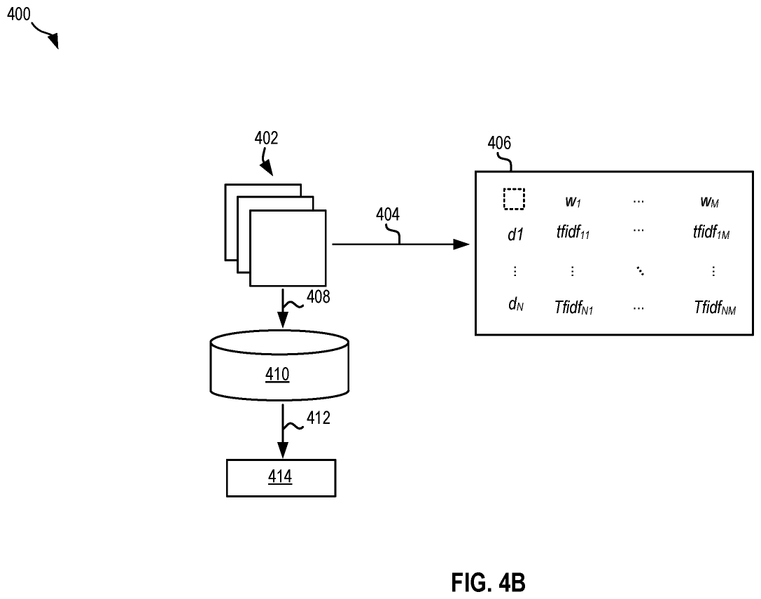

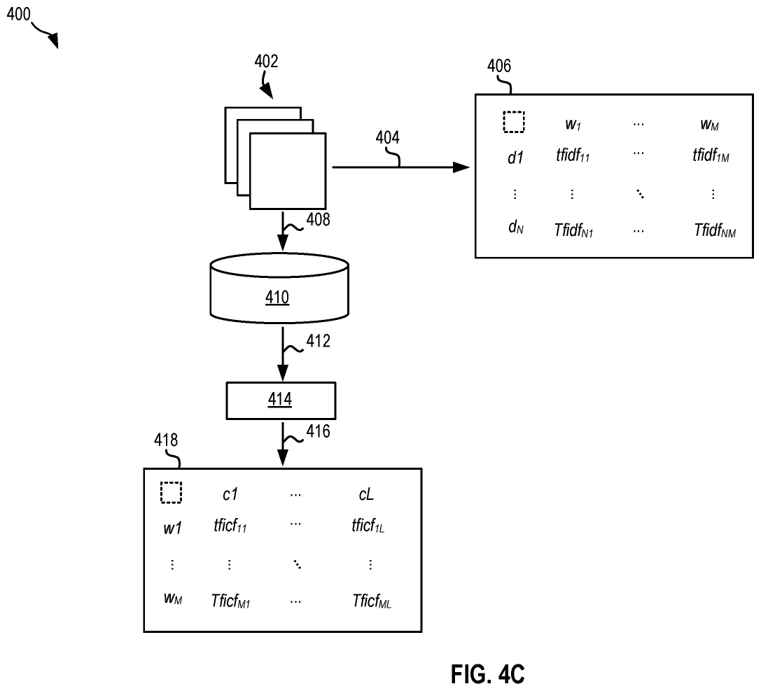

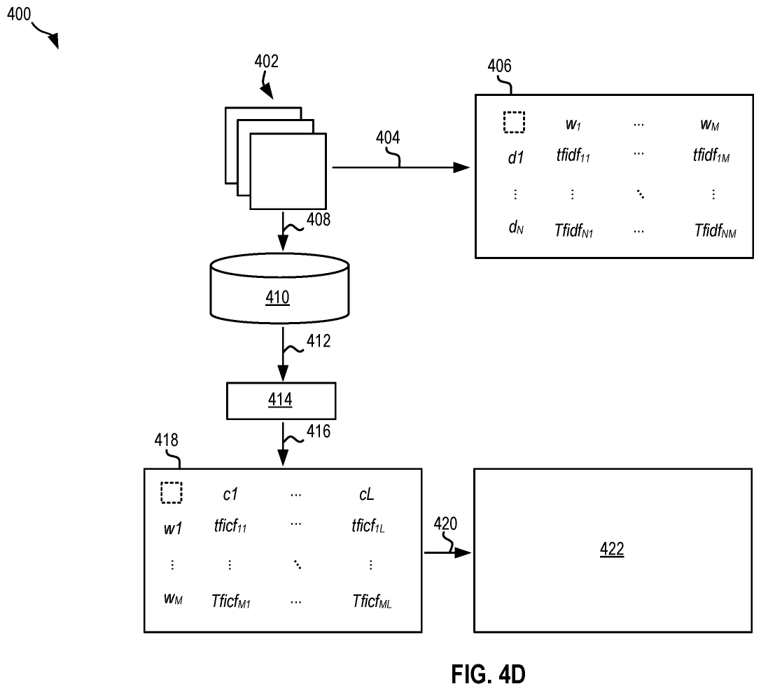

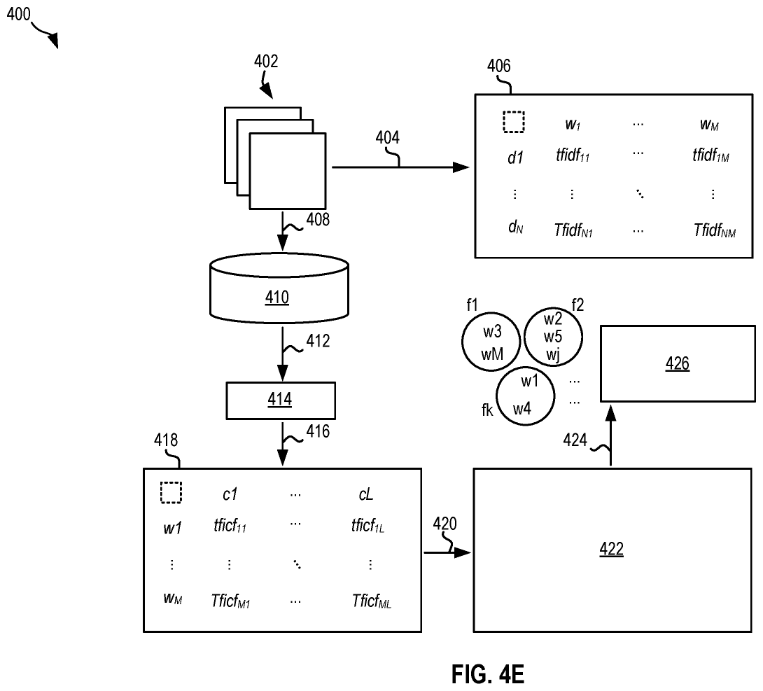

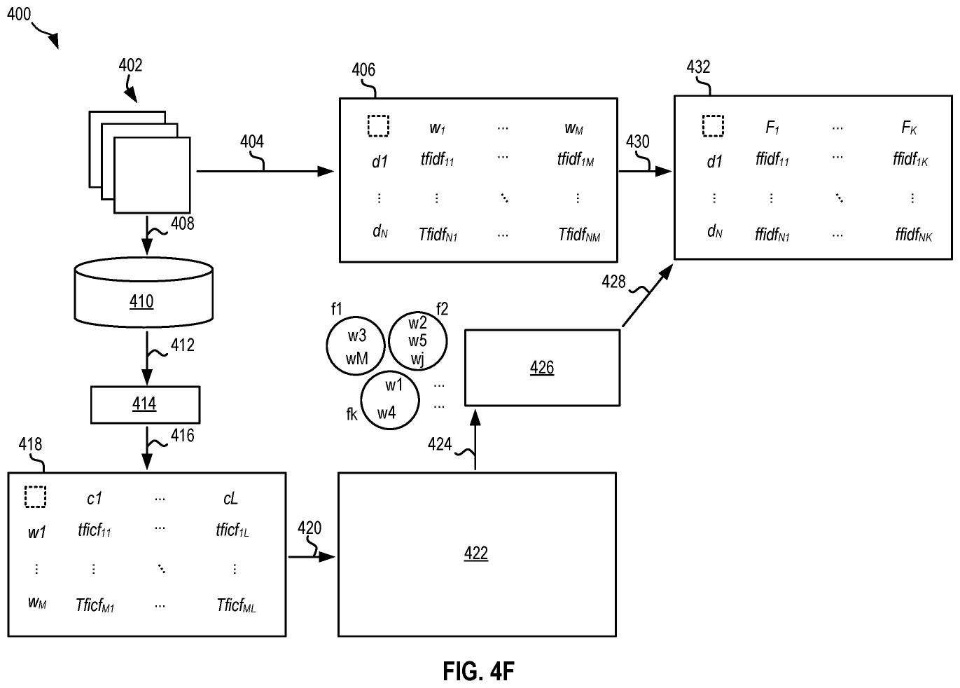

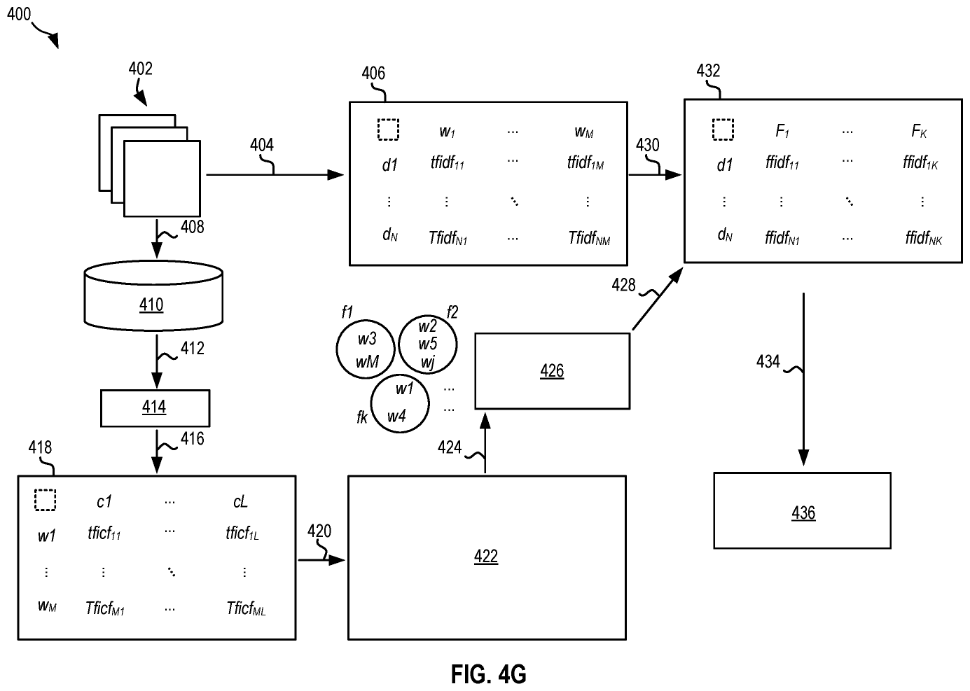

FIGS. 4A-4G depict an environment 400, in accordance with one embodiment. As an option, the present environment 400 may be implemented in conjunction with features from any other embodiment listed herein, such as those described with reference to the other FIGS. Of course, however, such environment 400 and others presented herein may be used in various applications and/or in permutations which may or may not be specifically described in the illustrative embodiments listed herein. Further, the environment 400 presented herein may be used in any desired environment.

It may be prefaced that FIGS. 4A-4G depict a progression of converting a relatively high dimension representation of documents to a relatively low dimension representation of the documents. Various of the operations described in FIGS. 4A-4G may be performed using one or more techniques described elsewhere above in operations of FIG. 3A and/or sub-operations of FIG. 3B.

With reference now to FIG. 4A, the environment 400 includes a plurality of documents 402. In one approach, at least some of the documents 402 are readable files. In operation 404, a first matrix 406 is generated based on words extracted from the documents 402. Elements, e.g., see tfidf₁₁, tfidf_{1M}, etc., of the first matrix 406 indicate a frequency that a given word, e.g., see w₁ and wₘ, appears in a given one of the documents 402.

Operation 408 of FIG. 4B, includes causing the documents 402 to be stored into deduplication storage 410. In operation 412, content of the documents 402 are split into chunks, e.g., see predetermined chunk extractor algorithm 414.

Referring now to FIG. 4C, in operation 416 a second matrix 418 is generated based on the deduplication chunks of the deduplication storage 410. Elements, e.g., see tficf₁₁, tficf_{1L}, etc., of the second matrix 418 indicate a frequency that a given word, e.g., see w1-w_{M}, appears in a given one of the deduplication chunks, e.g., see c1-cL.

Operation 420 of FIG. 4D includes perform analysis on the second matrix 418. More specifically, in some approaches, one or more predetermined analyzing operations 422 may be performed on the elements of the second matrix 418 to determine relational information about at least some of the elements with respect to at least some of the other elements. For example, in one preferred approach, performing analysis on the second matrix 418 may include calculating a distance between two words based on word vectors.

Referring now to FIG. 4E, operation 424 includes merging words of the documents 402 into clusters based on the analysis performed on the second matrix 418. In some approaches, a word clustering algorithm 426 may be executed to perform the word clustering to cluster words determined to have at least a predetermined degree of correlation. The clusters each thereby represent a different feature of at least one of the documents 402. For example, a first cluster f1 includes words w3 and wM, a second cluster f2 includes words w2, w5 and wj, and a third cluster fk includes words w1 and w4.

Operations 428 and 430 of FIG. 4F includes generating a third matrix 432 based on the first matrix 406 and the clusters. Elements, e.g., see ffidf₁₁, ffidf_{NK}, etc., of the third matrix 432 indicate a frequency that a given feature (cluster), e.g., see F₁-F_{K}, appears in a given one of the documents, e.g., see d1-d_{N}. Because the elements of the third matrix 432 are based on the clusters, the first matrix 406 is a relatively higher dimension representation of the documents 402, and the third matrix 432 is a relatively lower dimension representation of the documents 402.

Operation 434 of FIG. 4G includes performing text mining using the third matrix 432. In some approaches, operation 434 includes running a predetermined text mining program 436.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating a first matrix based on words extracted from documents;
generating a second matrix based on deduplication chunks, wherein the deduplication chunks include words of the documents;
performing word clustering based on an analysis performed on the second matrix, wherein each cluster of the words represents a feature of at least one of the documents;
generating a third matrix based on the first matrix and the clusters; and
performing text mining using the third matrix.

2. The computer-implemented method of claim 1, wherein the first matrix is a relatively higher dimension representation of the documents, wherein the third matrix is a relatively lower dimension representation of the documents.

3. The computer-implemented method of claim 2, wherein dimensions of the relatively higher dimension representation associated with the first matrix include the words of the documents, wherein dimensions of the relatively lower dimension representation associated with the third matrix include the features of the documents.

4. The computer-implemented method of claim 2, wherein performing text mining using the third matrix includes running a text mining program on the relatively lower dimension representation of the documents.

5. The computer-implemented method of claim 1, wherein elements of the first matrix indicate a frequency that a given word appears in a given one of the documents.

6. The computer-implemented method of claim 1, wherein elements of the second matrix indicate a frequency that a given word appears in a given one of the deduplication chunks.

7. The computer-implemented method of claim 1, wherein elements of the third matrix indicate a frequency that a given feature appears in a given one of the documents.

8. The computer-implemented method of claim 1, wherein generating the second matrix based on deduplication chunks includes: determining, for each chunk, a frequency that a first word occurs; determining a total count of the chunks; and determining a count of the chunks that the first word occurs in.

9. The computer-implemented method of claim 1, comprising: causing the documents to be stored into a deduplication storage, wherein content of the documents is split into the deduplication chunks during the documents being stored into the deduplication storage.

10. The computer-implemented method of claim 1, wherein data normalization is not performed to generate matrixes.

11. A computer program product, the computer program product comprising a computer readable storage medium having program instructions embodied therewith, the program instructions readable and/or executable by a computer to cause the computer to:
generate, by the computer, a first matrix based on words extracted from documents;
generate, by the computer, a second matrix based on deduplication chunks, wherein the deduplication chunks include words of the documents;
perform, by the computer, word clustering based on an analysis performed on the second matrix, wherein each cluster of the words represents a feature of at least one of the documents;
generate, by the computer, a third matrix based on the first matrix and the clusters; and
perform, by the computer, text mining using the third matrix.

12. The computer program product of claim 11, wherein the first matrix is a relatively higher dimension representation of the documents, wherein the third matrix is a relatively lower dimension representation of the documents.

13. The computer program product of claim 12, wherein dimensions of the relatively higher dimension representation associated with the first matrix include the words of the documents, wherein dimensions of the relatively lower dimension representation associated with the third matrix include the features of the documents.

14. The computer program product of claim 12, wherein performing text mining using the third matrix includes running a text mining program on the relatively lower dimension representation of the documents.

15. The computer program product of claim 11, wherein elements of the first matrix indicate a frequency that a given word appears in a given one of the documents.

16. The computer program product of claim 11, wherein elements of the second matrix indicate a frequency that a given word appears in a given one of the deduplication chunks.

17. The computer program product of claim 11, wherein elements of the third matrix indicate a frequency that a given feature appears in a given one of the documents.

18. The computer program product of claim 11, wherein generating the second matrix based on deduplication chunks includes: determining, for each chunk, a frequency that a first word occurs; determining a total count of the chunks; and determining a count of the chunks that the first word occurs in.

19. The computer program product of claim 11, the program instructions readable and/or executable by the computer to cause the computer to: cause, by the computer, the documents to be stored into a deduplication storage, wherein content of the documents is split into the deduplication chunks during the documents being stored into the deduplication storage.

20. A system, comprising:
a processor; and
logic integrated with the processor, executable by the processor, or integrated with and executable by the processor, the logic being configured to:
generate a first matrix based on words extracted from documents;
generate a second matrix based on deduplication chunks, wherein the deduplication chunks include words of the documents;
perform word clustering based on an analysis performed on the second matrix, wherein each cluster of the words represents a feature of at least one of the documents;
generate a third matrix based on the first matrix and the clusters; and
perform text mining using the third matrix.
